(19) United States
(12) Patent Application Publication
(10) Pub. No.: US 2006/0152356 A1
(43) Pub. Date: Jul. 13, 2006

(54) Disaster preventing system using digital radio communication

(76) Inventors: Han-Gyu Yang, Busan (KR); Jang-Seop Kim, Busan (KR)

Correspondence Address: CANTOR COLBURN, LLP, 55 GRIFFIN ROAD SOUTH, BLOOMFIELD, CT, 06002, US

(21) Appl. No.: 10/562,629

(22) PCT Filed: Jun. 25, 2004
(86) PCT No.: PCT/KR04/01559

§ 371 Date: Dec. 23, 2005

(30) Foreign Application Priority Data
Jun. 25, 2003 (KR) 10-2003-0041744

(51) Int. Cl. G08B 25/00; A62C 37/36; H04M 11/04; A62C 37/10; G08B 1/08; G08B 17/00

(52) U.S. Cl. 340/524; 340/584; 340/538.11; 169/60; 169/19; 379/40

(57) ABSTRACT

A disaster prevention system using a wireless digital communication is disclosed. The object of the present invention is capable of outputting a fire alarm when a fire occurs, displaying a location of the fire, and also driving an initial fire fighting device installed at the location of the fire so that the fire can be rapidly suppressed while still in its initial stage. It is another object of the present invention to provide a disaster prevention system using wireless communication capable of providing convenience of construction and reducing construction costs. It is a further object of the present invention to provide a disaster prevention system using wireless communication capable of stably operating even if an external AC power source is not supplied thereto. It is yet another object of the present invention to provide a disaster prevention system using wireless communication capable of automatically and rapidly calling corresponding office and corresponding office and corresponding manager when a fire occurs.

transmitting the fire information wirelessly, at least one or more repeaters for receiving the fire information inputted from the fire sensing units, and a signal processing unit for analyzing the fire information inputted from the repeaters, displaying the location of the fire when a fire occurs, and outputting a fire alarm.

The plurality of fire sensing units are installed in a plurality of positions in a building to sense fires. The repeaters are installed in each floor of the building to receive fire information inputted from the plurality of fire sensing units. A signal processing unit is installed in a main management suite to control and manage the entire building, for example, a guardroom to monitor a fire occurrence while it transmit/receives fire information in real-time to/from the repeater. If a fire occurs, the repeater and the signal processing unit display the location of the_fire, respectively, and output a fire alarm, so that occupants of the building and building managers are notified as to the location of the fires.

The disaster prevention system in the earlier application is implemented to communicate fire information between the fire sensing units and repeaters wirelessly, or implemented in a power line communication (PLC) manner using a DTMF signal as a carrier to modulate fire information between the repeater and the signal processing unit to be loaded to AC power. Therefore, the earlier application has advantages in that it is easy to construct since it does not additionally require a signal transmission line, thereby reducing the costs therefor.

However, the earlier application has disclosed only that the prior art disaster prevention system is designed to automatically call telephones of government offices such as a fire station, police station, etc., and a manager when a fire occurs, but does not propose specific elements to achieve the object.

Meanwhile, a sprinkler as an initial fire fighting device currently used is generally installed on the ceiling within a building and its head is sealed by solder. Therefore, if the sprinkler is heated to a temperature of above about 80° C., the solder sealing the head of the sprinkler is melted to automatically spray water at a predetermined pressure therefrom. As such, since the prior art sprinkler is implemented to operate only if the temperature is over 80° C., it still has problems that it may not operate properly even if a fire occurs.

### DISCLOSURE OF THE INVENTION

Therefore, the present invention has been made in view of the above problems, and it is an object of the present invention to provide a disaster prevention system using digital wireless communication capable of outputting a fire alarm when a fire occurs, displaying a location of the fire, and also driving an initial fire fighting device installed at the location of the fire so that the fire can be rapidly suppressed while still in its initial stage.

It is another object of the present invention to provide a disaster prevention system using wireless communication capable of providing convenience of construction and reducing construction costs.

It is a further object of the present invention to provide a disaster prevention system using wireless communication capable of stably operating even if external AC power is not supplied thereto.

It is yet another object of the present invention to provide a disaster prevention system using wireless communication capable of automatically and rapidly calling a corresponding office and corresponding manager when a fire occurs.

In accordance with the present invention, the above and other objects can be accomplished by the provision of a disaster prevention system comprising: a fire sensing unit for outputting fire information including fire sensing information and fire sensor identification information; and a repeater for displaying a location of the fire and outputting a fire alarm when receiving the fire information from the fire sensing unit; a signal processing unit for analyzing other fire information including the fire sensor identification information, fire occurrence information and repeater identification information inputted from the repeater, displaying the location of the fire, and outputting a fire alarm when sensing a fire, wherein said signal processing unit further includes a memory including identification information DB (data base) storing the fire sensor identification information, the fire sensing information and the repeater identification information, a fire occurrence detecting unit for confirming fire occurrence through other fire information inputted from the repeater, and sensing information regarding the location of the fire from the identification information DB through the fire sensor identification information when a fire occurs; a controlling unit including a fire signal processing unit for outputting a control signal driving the initial fire fighting device installed at the location of the fire, when inputting a fire occurrence signal from the fire occurrence detecting unit; and an initial fire fighting device drive unit for driving the initial fire fighting device in response to the control signal inputted from the fire signal processing unit.

As such, the disaster prevention system of the present invention outputs a fire alarm when sensing a fire, displays the location of the fire, notifies occupants of building and manager of the fire and the location of the fire, and controls operations of the initial fire fighting device installed at the location of the fire. Therefore, the fire can be initially and rapidly suppressed to safely protect the lives of occupants and their properties.

In accordance with an aspect of the disaster prevention system of the present invention, the repeater further includes a first power line communication interface unit for transmitting a carrier signal containing fire information to a fire signal processing unit, such that the carrier signal is mixed with AC power of a power line, and receiving the carrier signal from the fire signal processing unit, such that the carrier signal is mixed with AC power of power line, and also the signal processing unit further includes a second power line communication interface unit for receiving a carrier signal mixed with AC power of a power line from the first power line communication interface unit, and transmitting a carrier signal containing fire information, such that the carrier signal is mixed to AC power of the power line.

As such, the disaster prevention system of the present invention does not additionally require a signal transmission line between the repeater and the signal processing unit, and transmits/receives fire information therebetween through a power line. Therefore, it can provide convenience in construction and design, and can reduce the costs therefor.

In accordance with another aspect of the disaster prevention system of the present invention, the repeater further includes an inverter for converting an AC power source from the power line into a DC power source, a step-down transformer for converting the DC power source inputted from the inverter into a power source, and a DC power source supply including a charging circuit charged by the power inputted from the step-down transformer and a battery charged by power inputted from the charging circuit.

As such, the disaster prevention system of the present invention can be properly operated even when external AC power is not supplied thereto.

In accordance with yet another aspect of the disaster prevention system of the present invention, wherein the memory includes a telephone number DB for storing telephone numbers of a plurality of government offices and managers; and a voice memory for storing voice information related to an installed location of fire sensing unit including a fire sensor corresponding to fire sensor identification information, wherein the signal processing unit further includes a fire report processing unit fore selectively outputting telephone number of corresponding government offices and corresponding persons based on the telephone number DB and a telephone call control signal when inputting a fire occurrence detecting signal from a fire occurrence detecting unit, the disaster prevention system further comprises a call circuit unit including a dial controller for generating a DTMF signal corresponding to a telephone number inputted from a fire report processor and outputting it to a telephone office, a tone detecting unit for sensing a tone related to state information of a called telephone from the telephone office; and a voice transmitting unit for transmitting a voice signal to the called telephone, and a voice processing unit for outputting voice information through the call circuit unit under control of the fire report processor.

As such, the disaster prevention system of the present invention can automatically call government offices such as fire and police stations, and corresponding mangers, who will suppress a fire and control the location of the fire, a fire can be rapidly and fully suppressed and the extent of damage due to the fire occurrence can be prevented.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic block diagram of a disaster prevention system according to the present invention;

FIG. 2 is a block diagram of a fire sensing unit according to an embodiment of the present invention;

FIG. 3 is a block diagram of a repeater according to an embodiment of the present invention;

FIG. 4 is a block diagram of a signal processing unit according to an embodiment of the present invention;

FIG. 5 is a detailed view of the signal processing unit according to an embodiment of the present invention; and

FIG. 6 is a flow chart illustrating operations of a disaster prevention system according to an embodiment of the present invention.

### BEST MODE FOR CARRYING OUT THE INVENTION

With reference to the attached drawings, the aspects mentioned above and other added aspects will be described in detail so that those skilled in the art can easily understand and reproduce the present invention based on preferred embodiments.

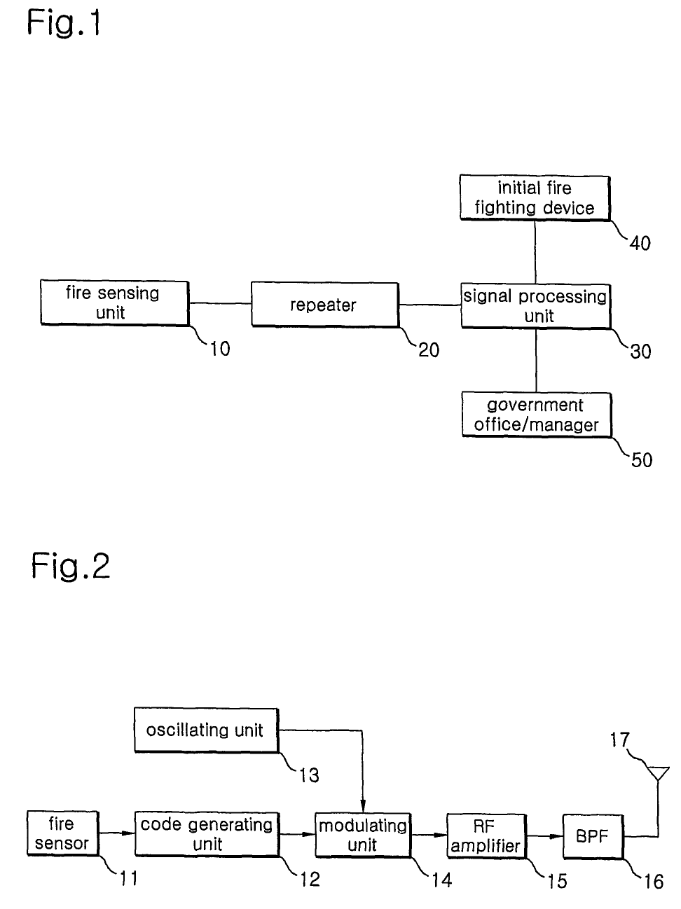

FIG. 1 is a schematic block diagram of a disaster prevention system according to the present invention. As shown in FIG. 1, the disaster prevention system according to the present invention comprises a plurality of fire sensing units 10, a plurality of repeater 20, a signal processing unit 30, an initial fire fighting device 40 and a government office/manager 50.

Each of the plurality of the fire sensing units 10 installed in a plurality of positions in a building senses a fire, and output fire information including fire sensor identification information and fire sensing information. Each repeater 20 installed in each floor of a building receives fire information outputted from the plurality of fire sensing units 10, displays the location of the fire when a fire occurs, and outputs a fire alarm.

In one embodiment of the present invention, a fire sensor 11 in respective fire sensing units 10 is preferably implemented to output a fire sensing signal when sensing heat of a temperature of about 50° C. Therefore, since a sensing temperature of the fire sensor 11 is lower than that of other fire sensor installed within the prior art initial fire fighting device by 30° C., sensing time of an initial fire in the present invention can be reduced by 10 minutes, compared with that of the prior art.

Also, each repeater 20 outputs other fire information including fire sensor identification information, fire sensing information and repeater identification information. The signal processing unit 30 installed in a main management suite such as a guardroom and the like for controlling and managing an entire building monitors a fire occurrence while it transmit/receives the other fire information to/from the repeater 20 in real-time.

The signal processing unit 30 displays a location of the fire when inputting a fire sensing signal, and outputs a fire alarm. Preferably, the signal processing unit 30 is implemented to control operation of the initial fire fighting device 40 installed at the location of the fire, therefore an initial fire can be completely suppressed at an initial fire stage. Also, the signal processing unit 30 outputs display information for displaying the location of the fire to the repeater 20 and a control signal for driving an alarm bell.

Preferably, the fire sensing unit 10 and the repeater 20 are implemented to communicate fire information wirelessly, also the repeater 20 and the signal processing unit 30 are implemented in a power line communication (PLC) manner using a DTMF signal as a carrier to modulate fire information to be mixed with AC power between the repeater and the signal processing unit.

The initial fire fighting device 40 includes a sprinkler, a fire shutter, a fan, an emergency door, an emergency lamp, etc. The sprinkler is preferably implemented to its open/close operations as a solenoid valve operates. Therefore, if a fire occurs, the sprinkler together with a fire shutter, a fan, an emergency door, an emergency lamp, etc is operated in response to a control signal of the signal processing unit 30 receiving the fire sensing signal from the fire sensor to spay water at a predetermined pressure, such that a fire can be suppressed while still in its initial stage.

The government office/manager 50 includes fire suppression and control organizations such as the fire station, police station, city hall, etc., occupants, guards and the like, and preferably, are implemented to transmit/receive fire information to/from the signal processing unit 30 through a wired/wireless communication network.

With reference to the drawings, the construction of a disaster prevention system of the present invention will be described in detail below. In the description of the embodiment of the present invention, contents of and drawings disclosed in Korean Patent No. 10-0373769 entitled “DISASTER PREVENTION SYSTEM” filed earlier than the present application by the present applicant will be cited so that those skilled in the art may easily comprehend the present invention.

FIG. 2 is a block diagram of a fire sensing unit according to one embodiment of the present invention. As shown in the drawing, the fire sensing unit 10 includes a fire sensor 11, a code generating unit 12 for generating an identification code of the fire sensor and a fire information code, an oscillating unit 13 generating a resonant frequency, a modulating unit 14 for synthesizing the identification code and fire information code to the resonant frequency inputted from the oscillating unit 13 and for modulating frequency of the result, a RF amplifier 15 for amplifying the level of modulated signal inputted from the modulating unit 14, and a band pass filter 16 for outputting only signals of a predetermined bandwidth from among signals inputted from the RF (Radio Frequency) amplifier 15 to a transmission antenna 17.

The fire sensing unit 10 includes a battery and a battery re-charger so that it can be operated without external power supply.

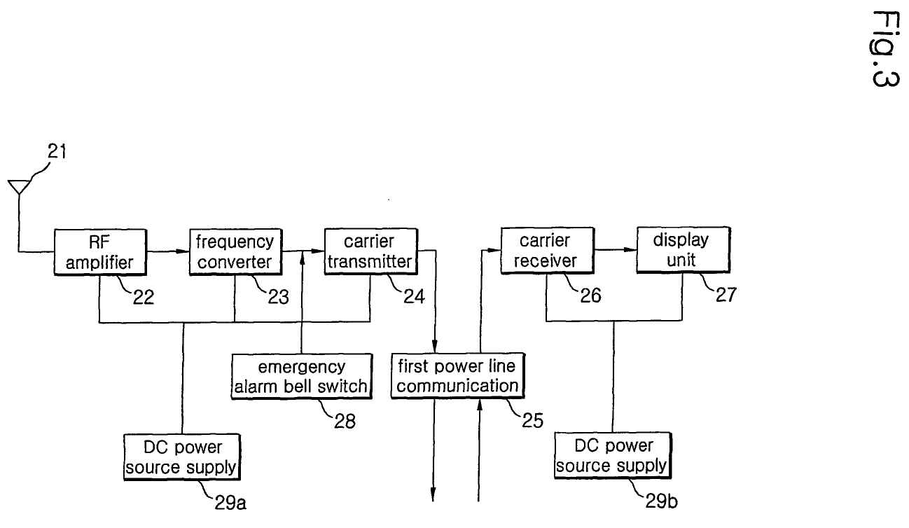

FIG. 3 is a block diagram of a repeater according to an embodiment of the present invention. As shown in the drawing, the repeater 20 includes a reception antenna 21 for receiving a fire information signal transmitted from the transmission antenna 17, a RF amplifier 22 for amplifying a frequency of signals inputted from the reception antenna 21, a frequency converter 23 for converting the amplified signal inputted from the RF amplifier 22 into an intermediate frequency, a carrier transmitter 24 for amplifying a frequency inputted from the frequency converter 23 to be loaded to a DTMF (Dual Tone Multi-Frequency) carrier, and transmitting it, a first power line communication (PLC) interface unit 25 for transmitting a signal from the carrier transmitter 24, which is mixed to an AC power of a power line, to the signal processing unit 30, and receiving the DTMF carrier signal from the signal processing unit 30, which is mixed to AC power of power, a carrier receiver 26 for receiving fire information inputted from the first PLC interface unit 25, a display unit 27 for displaying information of the location of the fire received from the carrier receiver 26, and an emergency bell switch 28.

In accordance with another aspect of the present invention, the repeater 20 preferably includes DC power supplies 29a and 29b.

The DC power supplies 29a and 29b input external AC power to charge a battery with a charge capacity of 12V and supply a driving power to each element of the repeater 20 when an electric power failure occurs. Each of the DC power supplies 29a and 29b includes an inverter for converting external AC power, for example, AC power of 220V into DC power of 220V, a step-down transformer for converting the DC power into DC power of 12V, and a charging circuit unit for charging a battery with a power of 12V inputted from the step-down transformer.

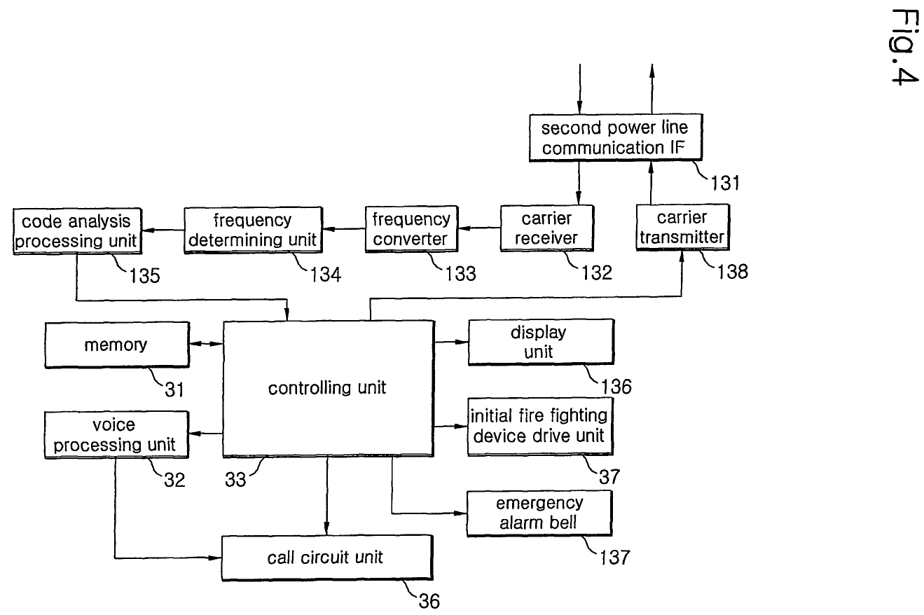

FIG. 4 is a block diagram of a signal processing unit according to one embodiment of the present invention. As show in the drawing, the signal processing unit 30 comprises a second power line communication (PLC) interface unit 131 for receiving a DTMF carrier signal mixed with AC power of the power line from the first PLC interface unit 25, or transmitting a DTMF carrier signal containing fire information, which is mixed to AC power of a power line, a carrier receiver 132 for receiving a signal inputted from the second PLC interface unit 131, a frequency converter 133 for converting a signal inputted from the carrier receiver 132 into an intermediate frequency, a frequency discriminator 134 for generating a modulation signal used in the fire sensing unit 10, and for reproducing an original signal as the modulation signals is removed from the receiving signals by multiplying the modulation signal by the intermediate frequency signal converted of the frequency converter 133, a code analysis processing unit 135 for separating code signal from signals reproduced from the frequency discriminator 134 and transmitting the same, a controlling unit 33 for determining whether there is a fire by comparing the code signal inputted from the code analysis processing unit 135 with other code signal stored in a memory, displaying the location of the fire on a display unit 136 based on the determination result, and outputting a fire alarm, through an emergency bell 137, and fire information, a carrier transmitter 138 for outputting the fire information inputted from the controlling unit 33 to the repeater 20 through the second PLC interface unit 131, and a memory 31.

Here, the display unit 136 displays the location of the fire, fire occurrence time, and fire occurrence day, and is preferably implemented with a LCD (Liquid Crystal Display) or FND (Multisegmented LED Displays), but one will appreciate that the embodiments are not limited to such a display unit.

In one preferred embodiment, an exclusive fire line made of a fire-resistant cable can be installed between the first and second PLC interface units 25 and 131, in addition to a pre-installed power line. Such an exclusive fire line made of a fire-resistant cable as a supplementary data line operates, in the case that the first and second PLC interface units 25 and 131 cannot communicate with each other since the pre-installed power line is damaged by heat when a fire occurs.

Referring to the drawing, the signal processing unit will be described in detail below.

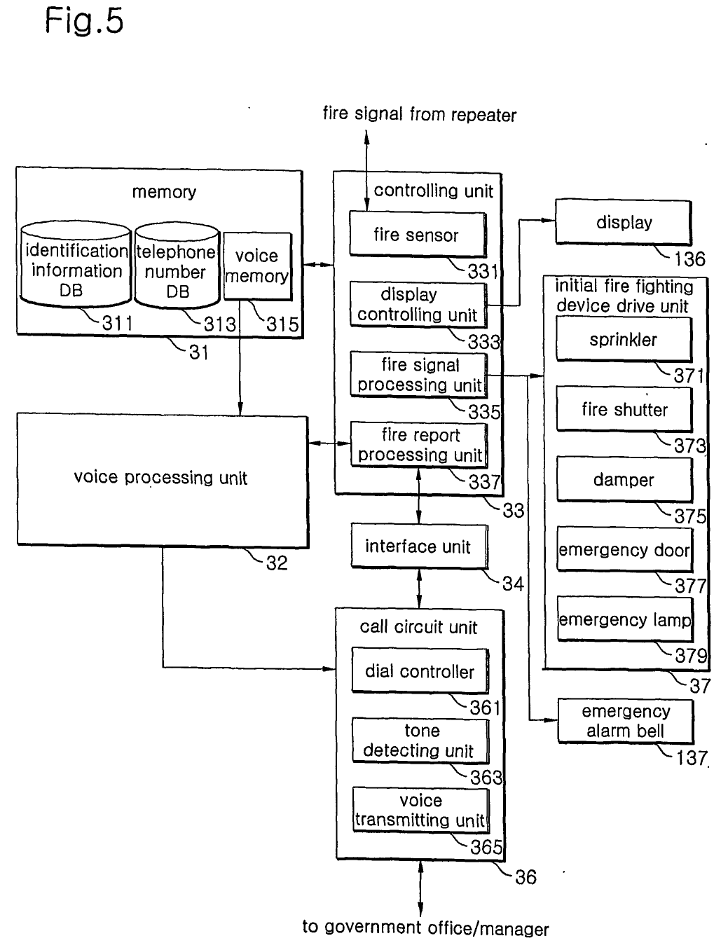

FIG. 5 is a detailed view of the signal processing unit according to one embodiment of the present invention.

As shown in the drawing, the signal processing unit 30 includes a memory 31, a controlling unit 33, an initial fire fighting device drive unit 37, a voice processing unit 32, an interface unit 34, and a call circuit unit 36.

The memory 31 is preferably implemented with a nonvolatile memory in which data is electrically erasable or programmable, for example, a flash memory including an EEPROM (Electrical Erasable Programmable ROM). The memory 31 includes an identification information DB (Database) for storing a main program for operations of the entire system, fire sensor identification information, fire occurrence information and repeater identification information.

In an additional aspect of the present invention, the memory 31 further includes a telephone DB 313 for storing telephone numbers of a plurality of government offices/managers, and a voice memory 315. Preferably, the voice memory 315 includes alarm message information related to fire occurrence and voice information related to an installed location of a fire sensor corresponding to fire sensor identification information.

The controlling unit 33 is preferably implemented with a microprocessor integrated with a ROM (Read-Only Memory), a RAM (Random Memory Access), a timer, and peripheral devices therein, and includes a fire occurrence detecting unit 331, a display controlling unit 333, a fire signal processing unit 335, and a fire report processing unit 337.

The fire occurrence detecting unit 331 inputs fire sensing information including fire sensor identification information of a fire sensor installed at the location of the fire, repeater identification information and fire occurrence information from the repeater 20 to confirm whether a fire occurs, and detects information related to a location of the fire from identification information DB 311 stored in the memory.

The display controlling unit 333 displays the location of the fire through the detecting information inputted from the fire occurrence detecting unit 331 on the display unit 136.

The fire signal processing unit 335 drives an emergency bell 137 if a fire occurrence sensing signal is inputted from the fire occurrence detecting unit 331, and outputs a control signal for driving the initial fire fighting device 40 installed at the location of the fire.

The fire report processing unit 337 outputs a telephone call control signal and a telephone number of a government office/manager sequentially pre-stored in a telephone number DB 313 if the fire occurrence sensing signal is inputted from the fire occurrence detecting unit 331. The fire report processing unit 337 outputs a next telephone number from the telephone number DB 313 if a response signal in response to a telephone call is not inputted from the call circuit unit 36 within a predetermined time. Also, the fire report processing unit 337 is controlled to output fire occurrence information and corresponding voice information stored in the voice memory, for example, voice information related to the location of the fire, if a telephone response signal is inputted from a called party's telephone.

The initial fire fighting device drive unit 37 drives a sprinkler 371, a fire shutter 373, a damper 375, an emergency door 377 and an emergency lamp 379.

In one embodiment, the initial fire fighting device drive unit 37 controls operations of a solenoid valve installed in the sprinkler 371 so that water at a predetermined pressure, from the sprinkler 371, is sprayed according to an open/close operations of the solenoid valve. Therefore, a fire can be initially suppressed.

In one embodiment, the initial fire fighting device drive unit 37 controls an operation switch which is newly or was previously installed to the fire shutter 373, the emergency door 377, and the emergency lamp 379. In one embodiment, the emergency lamp 379 further includes a voice synthetic IC (Integrated Chip) and a speaker, and may output a guide broadcast notifying building occupants of the location of emergency exits, if a driving control signal is inputted from the signal processing unit 30.

The voice processing unit 32 reads fire occurrence information and corresponding voice information, for example, voice information related to a place where a fire occurs, from the voice memory 315 in response to a control of the fire report processing unit 337, and then proceeds to perform a voice synthetic operation to output it to the call circuit unit 36.

The interface unit 34 interfaces data and signals between the controlling unit 33 and the call circuit unit 36. Also, if a telephone number of the monitoring center is inputted together with a call control signal for calling monitoring center from the controlling unit 33, they are outputted to the call circuit unit 36 according to a call processing protocol. Here, since the call processing protocol is well-known, a detailed description thereof will be omitted.

The call circuit unit 36 for inputting the call control signal of the monitoring center of the controlling unit 33, generating a DTMF signal corresponding to a telephone number of the monitoring center, and outputting it to a telephone office. The call circuit unit 36 includes a dial controller 361, a tone detecting unit 363 and a voice transmitting unit 365.

The dial controller 361 includes a DTMF signal generating unit for transmitting a called party's telephone number and a telephone circuit connection circuit for connecting to a PSTN (Public Switched Telephone Network). The dial controller 361 achieves a state for transmitting a dial tone by activating the telephone circuit connection circuit, if a call control signal of a monitoring center is inputted from the controlling unit 33. After that, if the telephone number of the monitoring center is inputted from the controlling unit 33, the dial controller 361 generates a DTMF signal corresponding to the number to output it to the PSTN.

The tone detecting unit 363 detects a tone signal related to state information of a called party's telephone, which is transmitted to a called party's telephone from a telephone company. The tone signal includes a ring back tone signal indicating that a called party's telephone is calling, and a busy signal indicating that a called party's telephone is already receiving another telephone call.

The voice transmitting unit 365 converts an audio signal inputted from the voice processing unit 32 into an electric signal to output it a called party's telephone.

With reference to the drawing, a method for processing fire information received by the signal processing unit will be described in detail below.

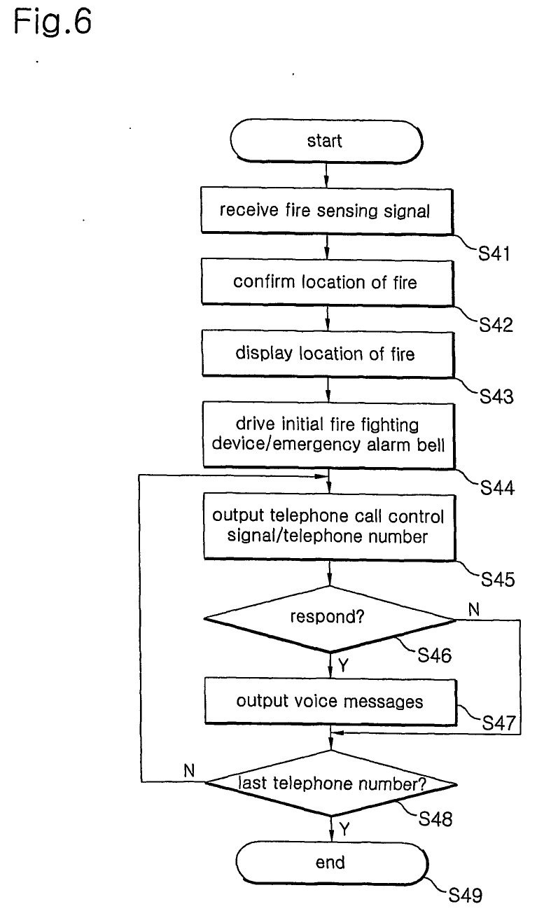

FIG. 6 is a flow chart illustrating operations of a disaster prevention system according to an embodiment of the present invention.

The controlling unit 33 analyzes fire information including fire sensor identification information, fire occurrence information and repeater identification information, and determines whether a fire sensing signal is received. If the fire sensing signal is received at step S41, the controlling unit confirms and displays the location of the fire at steps S42 and S43.

After that, the controlling unit 33 outputs control signals to drive an initial fire fighting device 40 including a sprinkler 371, a fire shutter 373, a damper 375, an emergency door 377 and an emergency lamp 379, etc., and an emergency bell 137 at step S44. In one embodiment, the sprinkler 371 sprays water at a predetermined pressure according to open/close operations of a solenoid valve driven by a control signal inputted from the controlling unit 33, therefore the fire can be suppressed while still in its initial stage. Namely, in the prior art disaster prevention system, a sprinkler is implemented to operate only if it is heated to a temperature of above 80° C. when a fire occurs. Meanwhile, the sprinkler 371 according to one embodiment of the present invention is operated as a fire sensor 11 outputs a fire sensing signal if it senses a temperature of about 50° C. Therefore, it can correctly operate when a fire occurs.

After that, the controlling unit 33 sequentially selects one of telephone numbers of government offices/managers, which are stored in a telephone number DB 315, and then outputs the selected telephone number together with a telephone call control signal to the dial controller 361 at step S45. The call circuit unit 36 inputting the telephone call control signal from the controlling unit 33 at the step S45 generates a DTMF signal corresponding to the selected telephone number to output it to the telephone office.

After that, the controlling unit 33 detects a tone signal related to state information of a called party's telephone from the telephone office. If the detected tone signal is a ring back tone signal, the controlling unit counts the ring back tone signal and determines whether there is a response within a predetermine time at step S46. If there is a response, corresponding voice information stored in the voice memory 315 is outputted at step S47. If there is not, the controlling unit determines whether the telephone number is the last number as step S48. Meanwhile, if the detected tone signal is a busy tone signal, the controlling unit determines whether the telephone number is the last number at step S48.

After performing the step 48, if the telephone number is not the last number, the controlling unit selects the next telephone number of government offices/mangers and outputs the selected telephone number together with a telephone call control signal to the dial controller 361 at step S45. Meanwhile, if the telephone number is the last number, the process is ended at step S49.

The controlling unit according to the present invention can be implemented to automatically call all the telephone numbers of government offices/mangers stored in the telephone number DB 315 when a fire occurs. Therefore the government offices and managers can rapidly respond to fires.

### INDUSTRIAL APPLICABILITY

As apparent from the above description, the disaster prevention system of the present invention constructed to have a dual alarm system, in which the repeaters and the signal processing unit have a display unit and an emergency bell, respectively, can notify occupants of the building and building managers of a fire and the location of the fire when the fire occurs. Especially, since the signal processing unit controls operations of the initial fire fighting device installed in the location of the fire, a fire can be initially and rapidly suppressed and thusly the occupants and their properties can be safely protected therefrom.

Also, the disaster prevention system of the present invention can automatically call government offices such as a fire station and police station, and corresponding mangers, therefore a fire can be fully suppressed and the location of the fire can be controlled.

Also, since the fire sensing unit and the repeater can be implemented to communicate fire information wirelessly and the repeater and the signal processing unit can be implemented to communicate fire information in a power line communication manner, the disaster prevention system of the present invention does not additionally require a signal transmission line. Therefore, it can provide convenience of construction and reduce the costs therefor.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A disaster prevention system comprising:
a fire sensing unit for outputting fire information including fire sensing information and fire sensor identification information; and
a repeater for displaying a location of the fire, and outputting a fire alarm when receiving fire information from the fire sensing unit;
a signal processing unit for analyzing other fire information including the fire sensor identification information, fire occurrence information and repeater identification information inputted from the repeater, displaying the location of the fire, and outputting a fire alarm when sensing a fire,
wherein said signal processing unit further includes:
a memory including an identification information DB (DataBase) for storing the fire sensor identification information, the fire sensing information, and the repeater identification information;
a fire occurrence detecting unit for confirming fire occurrence through other fire information inputted from the repeater, and sensing information regarding the location of the fire from the identification information DB through the fire sensor identification information when a fire occurs;
a controlling unit including a fire signal processing unit for outputting a control signal driving the initial fire fighting device installed at the location of the fire, when inputting a fire occurrence signal from the fire occurrence detecting unit; and
an initial fire fighting device drive unit for driving the initial fire fighting device in response to the control signal inputted from the fire signal processing unit.

2. The system as set forth in claim 1, further comprising:
a sprinkler performing opening/closing operations by a solenoid valve driven in response to a control signal inputted from the initial fire fighting device drive unit.

3. The system as set forth in claim 2, wherein said repeater further includes a first power line communication interface unit for transmitting a carrier signal containing the fire information to the signal processing unit, such that the carrier signal is mixed with AC power of a power line, and for receiving the carrier signal from the signal processing unit, such that the carrier signal is mixed with AC power of a power line, and
wherein said signal processing unit further includes a second power line communication interface unit for receiving a carrier signal mixed with AC power of a power line from the first power line communication interface unit, and for transmitting a carrier signal containing a control signal to the initial fire fighting device, such that the carrier signal is mixed with AC power of the power line.

4. The system as set forth in claim 3, wherein further comprising an exclusive fire line as a fire-resistant cable between the first and second power line communication interface units, in addition a pre-installed power line.

5. The system as set forth in claim 1, wherein said repeater further comprises:
an inverter for converting AC power from the power line into DC power;
a step-down transformer for converting DC power inputted from the inverter into power; and
a DC power source supply including a charging circuit for charging a battery with the power inputted from the step-down transformer.

6. The system as set forth in claim 1, wherein said memory further comprises:
a telephone number DB for storing telephone numbers of a plurality of government offices and managers; and
a voice memory for storing voice information related to an installed location of the fire sensing unit including a fire sensor corresponding to the fire sensor identification information;
wherein said signal processing unit further comprises a fire report processing unit for selectively outputting telephone numbers of corresponding government offices and corresponding persons based on the telephone number DB and a telephone call control signal when inputting a fire occurrence sensing signal from the fire occurrence detecting unit,
the system further comprising:
a call circuit unit including:
a dial controller for generating a DTMF (Dual Tone Multi-Frequency) signal corresponding to a telephone number inputted from the fire report processor, and outputting it to a telephone office;
a tone detecting unit for detecting a tone related to state information of a called telephone from the telephone office; and
a voice transmitting unit for transmitting a voice signal to the called telephone; and
a voice processing unit for outputting voice information through the call circuit unit under control of the fire report processor.

7. The system as set forth in claim 2, wherein said repeater further comprises:
an inverter for converting AC power from the power line into DC power;
a step-down transformer for converting DC power inputted from the inverter into power; and
a DC power source supply including a charging circuit for charging a battery with the power inputted from the step-down transformer.

8. The system as set forth in claim 3, wherein said repeater further comprises:
an inverter for converting AC power from the power line into DC power;
a step-down transformer for converting DC power inputted from the inverter into power; and
a DC power source supply including a charging circuit for charging a battery with the power inputted from the step-down transformer.

9. The system as set forth in claim 4, wherein said repeater further comprises:
an inverter for converting AC power from the power line into DC power;
a step-down transformer for converting DC power inputted from the inverter into power; and
a DC power source supply including a charging circuit for charging a battery with the power inputted from the step-down transformer.

10. The system as set forth in claim 2, wherein said memory further comprises:
a telephone number DB for storing telephone numbers of a plurality of government offices and managers; and
a voice memory for storing voice information related to an installed location of the fire sensing unit including a fire sensor corresponding to the fire sensor identification information;
wherein said signal processing unit further comprises a fire report processing unit for selectively outputting telephone numbers of corresponding government offices and corresponding persons based on the telephone number DB and a telephone call control signal when inputting a fire occurrence sensing signal from the fire occurrence detecting unit,
the system further comprising:
a call circuit unit including:
a dial controller for generating a DTMF (Dual Tone Multi-Frequency) signal corresponding to a telephone number inputted from the fire report processor, and outputting it to a telephone office;
a tone detecting unit for detecting a tone related to state information of a called telephone from the telephone office; and
a voice transmitting unit for transmitting a voice signal to the called telephone; and
a voice processing unit for outputting voice information through the call circuit unit under control of the fire report processor.

11. The system as set forth in claim 3, wherein said memory further comprises:
a telephone number DB for storing telephone numbers of a plurality of government offices and managers; and
a voice memory for storing voice information related to an installed location of the fire sensing unit including a fire sensor corresponding to the fire sensor identification information;
wherein said signal processing unit further comprises a fire report processing unit for selectively outputting telephone numbers of corresponding government offices and corresponding persons based on the telephone number DB and a telephone call control signal when inputting a fire occurrence sensing signal from the fire occurrence detecting unit,
the system further comprising:
a call circuit unit including:
a dial controller for generating a DTMF (Dual Tone Multi-Frequency) signal corresponding to a telephone number inputted from the fire report processor, and outputting it to a telephone office;
a tone detecting unit for detecting a tone related to state information of a called telephone from the telephone office; and
a voice transmitting unit for transmitting a voice signal to the called telephone; and
a voice processing unit for outputting voice information through the call circuit unit under control of the fire report processor.

12. The system as set forth in claim 4, wherein said memory further comprises:
a telephone number DB for storing telephone numbers of a plurality of government offices and managers; and
a voice memory for storing voice information related to an installed location of the fire sensing unit including a fire sensor corresponding to the fire sensor identification information;
wherein said signal processing unit further comprises a fire report processing unit for selectively outputting telephone numbers of corresponding government offices and corresponding persons based on the telephone number DB and a telephone call control signal when inputting a fire occurrence sensing signal from the fire occurrence detecting unit,
the system further comprising:
a call circuit unit including:
a dial controller for generating a DTMF (Dual Tone Multi-Frequency) signal corresponding to a telephone number inputted from the fire report processor, and outputting it to a telephone office;
a tone detecting unit for detecting a tone related to state information of a called telephone from the telephone office; and
a voice transmitting unit for transmitting a voice signal to the called telephone; and
a voice processing unit for outputting voice information through the call circuit unit under control of the fire report processor.
